(19) United States
(12) Patent Application Publication
(10) Pub. No.: US 2026/0152004 A1
(43) Pub. Date: Jun. 4, 2026

(54) COMPLIANCE ASSEMBLY WITH FLEX LIMITER

(71) Applicant: MEMJET TECHNOLOGY LIMITED, Dublin 2 (IE)

(72) Inventors: Glenn Horrocks, North Ryde (AU); Norman Berry, North Ryde (AU)

(21) Appl. No.: 19/395,251

(22) Filed: Nov. 20, 2025

Related U.S. Application Data
(60) Provisional application No. 63/727,973, filed on Dec. 4, 2024.

(51) Int. Cl. B41J 2/175; B41J 29/377

(52) U.S. Cl. CPC B41J 2/175; B41J 29/377

(57) ABSTRACT

A compliance assembly includes: an ink duct having duct sidewalls and an opening defined in a roof of the ink duct; a gasket covering the opening, the gasket having a compliance portion communicating with ink in the ink duct; and a rigid member urged against the gasket for sealing the opening. The compliance portion is spaced apart from the rigid member and the rigid member includes a tongue extending towards a floor of the ink duct, such that flexing of the compliance portion is limited by the tongue.

### CROSS-REFERENCE TO RELATED APPLICATIONS

This application claims the benefit of priority to U.S. Provisional Patent App. Ser. No. 63/727,973 filed Dec. 4, 2024, entitled “COMPLIANCE ASSEMBLY FOR INKJET PRINTING SYSTEMS”, the contents of which being incorporated herein by reference in its entirety.

### TECHNOLOGICAL FIELD

This disclosure relates to a compliance assembly for inkjet printing systems. It has been developed primarily to provide ink pressure dampening in inkjet printheads, as well as other ink delivery components of inkjet printing systems.

### BACKGROUND

The Applicant has developed a range of Memjet® inkjet printers as described in, for example, WO2011/143700, WO2011/143699 and WO2009/089567, the contents of which are incorporated herein by reference in its entirety. Memjet® printers employ one or more stationary inkjet printheads in combination with a feed mechanism which feeds print media past the printhead in a single pass. Memjet® printers therefore provide much higher printing speeds than conventional scanning inkjet printers.

Ink pressure dampening is an important feature in pagewide printheads having a relatively large volume of ink that experiences rapid hydrostatic pressure changes when multiple nozzles start or stop printing. Pressure spikes which occur when printing suddenly stops need to be absorbed by the system, preferably as closely to the nozzles as possible. Relatively long printheads lacking pressured-dampeners can exhibit print quality defects or ink drooling from nozzles when printing is stopped.

U.S. Pat. No. 8,025,383 (the contents of which are incorporated herein by reference in its entirety) describes a printhead having a series of airboxes positioned above longitudinal ink channels. The airboxes serve to absorb hydrostatic pressure fluctuations along the ink channels. However, airboxes are not suitable for use with degassed inks.

U.S. Pat. No. 10,343,402 (the contents of which are incorporated herein by reference in its entirety) describes a printhead having longitudinal ink channels with a compliant gasket sealing an open roof of each channel. The compliant gasket incorporates bellows hanging into each ink channel, which provide excellent pressure-dampening in response to dynamic pressure fluctuations.

While the compliant gasket described in U.S. Pat. No. 10,343,402 is highly suited for ink pressure dampening during printing, axial sealing of the compliant gasket against ink channel sidewalls requires relatively high compression forces. Without high compression forces, adequate sealing of the ink channels may not be achieved. On the other hand, high compression forces can lead to bowing of the ink manifold and potential failures (e.g., die cracking) during manufacturing.

It would therefore be desirable to provide a compliance assembly, suitable for an inkjet printhead, having a reliable seal that does not require high axial compression forces. It would further be desirable to provide a compliance assembly that dynamically responds to ink pressure fluctuations during printing, and further enables a printhead to be primed with ink under positive pressure from an ink delivery system.

### SUMMARY

In a first aspect, there is provided a compliance assembly for dampening ink pressure fluctuations in an inkjet printing system. In one embodiment, the assembly includes an ink duct having duct sidewalls and an opening defined in a roof of the ink duct; a gasket covering the opening, the gasket including a compliance portion communicating with ink in the ink duct; and a rigid member urged against the gasket for sealing the opening. The compliance portion is spaced apart from the rigid member; and the rigid member includes a tongue extending towards a floor of the ink duct, such that flexing of the compliance portion is limited by the tongue.

In a second aspect, there is provided a printhead comprising the compliance assembly described above.

Preferred embodiments are described hereinbelow in the accompanying claims.

As used herein, the term “ink” is taken to mean any printing fluid, which may be printed from an inkjet printhead. The ink may or may not contain a colorant. Accordingly, the term “ink” may include conventional dye-based and pigment-based inks, infrared inks, UV inks, fixatives (e.g. pre-coats and finishers), functional fluids (e.g. solar inks, sensing inks), 3D printing fluids, biological fluids and the like. Where reference is made to fluids or printing fluids, this is not intended to limit the meaning of “ink” herein.

As used herein, the term “mounted” includes both direct mounting and indirect mounting via an intervening part.

### BRIEF DESCRIPTION OF DRAWINGS

Embodiments of the present disclosure will now be described by way of example only with reference to the accompanying drawings, in which:

FIG. 1 is a top perspective of a printhead according to one embodiment;

FIG. 2 is a bottom perspective of the printhead shown in FIG. 1;

FIG. 3 is a top perspective of the printhead shown in FIG. 1 with an upper second PCB removed;

FIG. 4 is a top perspective of the printhead shown in FIG. 3 with compliance units removed;

FIG. 5 is a sectional perspective of the printhead shown in FIG. 1;

FIG. 6 is an exploded perspective of compliance units;

FIG. 7 is an exploded top perspective of a two-part manifold; and

FIG. 8 is an exploded bottom perspective of the two-part manifold.

### DETAILED DESCRIPTION

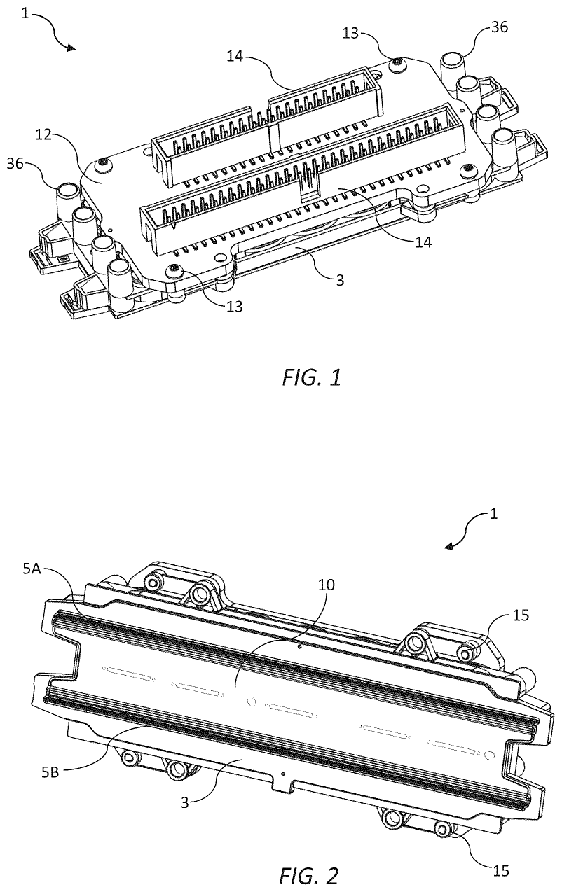

Referring to FIGS. 1 to 8, there is shown an inkjet printhead 1 comprising a compliance assembly according to one aspect of the present disclosure. The printhead 1 is typically of the type described in U.S. Provisional Patent Application Ser. No. 63/666,377 filed 1 Jul. 2024 and U.S. Provisional Patent Application Ser. No. 63/668,497 filed 8 Jul. 2024. However, it will be appreciated that the compliance assembly described herein is suitable for use in any inkjet printhead and, indeed, any suitable part of an inkjet printing system having an ink channel (e.g. ink delivery system, ink connectors, etc.).

Referring to FIGS. 2 to 4, the printhead 1 comprises an elongate manifold 3 configured for supplying ink and power/data to a first row of print chips 5A and a second row of print chips 5B mounted to a lower face thereof. Additionally, a first PCB 10 is mounted to a lower face of the manifold 3 between the first and second rows of print chips 5A and 5B. The first PCB 10 extends generally co-extensively with the rows of print chips along the length of the printhead 1 and distributes power and data to both the first row 5A and the second row 5B of print chips.

Each of the first and second rows of print chips 5A and 5B typically contains six individual print chips 5 butted end-on-end for a total of twelve print chips in the printhead 1. Of course, a greater or fewer number of print chips 5 may be provided in each row (e.g. 2 to 8 print chips). Print chips 5 configured for butting end-on-end in a pagewide arrangement will be known to the person skilled in the art. For example, the Applicant's dropped nozzle triangle architecture for linking print chips in a row is described in U.S. Pat. No. 7,290,852, the contents of which are incorporated herein by reference in its entirety.

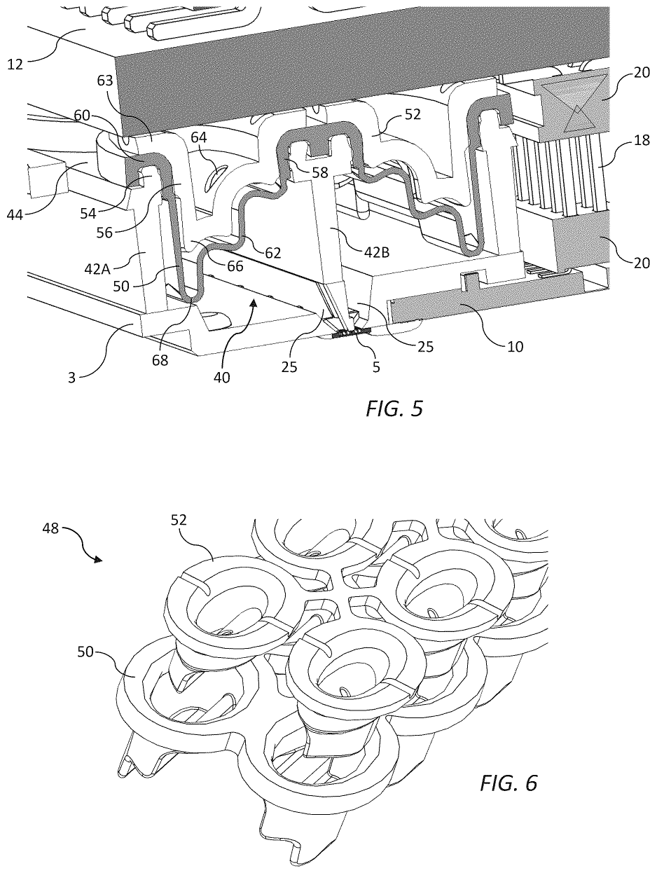

As shown in FIGS. 1 and 5, a second PCB 12 is fastened to an upper face of the manifold 3 (via screw fasteners 13 received in screw bosses 15) and extends parallel with the first PCB 10 mounted to the lower face of the manifold 3. The second PCB 12 communicates power and data signals to the first PCB 10, as well as providing a rigid backbone for the printhead 1. For this latter requirement, the second PCB 12 is comprised of a rigid polymer substrate (e.g., conventional FR4 substrate) with a thickness of at least 3 mm. Power and data ports 14 extend from an upper surface of the second PCB 12 for connection to an external print controller and/or power source (not shown).

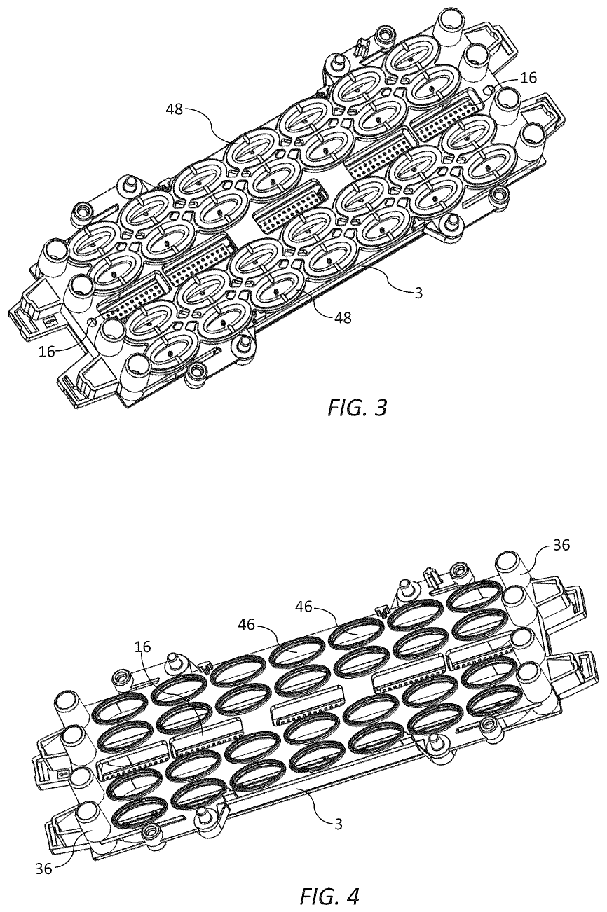

As best shown in FIGS. 3 to 5, the first PCB 10 receives power and data from the second PCB 12 via through-holes 16 defined through a thickness of the manifold 3 and positioned along a central longitudinal axis thereof. Each through-hole 16 receives a plurality of electrical connector pins 18, which interconnect the first PCB 10 with the second PCB 12. Upper and lower insulator blocks 20 group the connector pins 18 into discrete units, which can be readily assembled and placed in respective through-holes 16 during manufacturing.

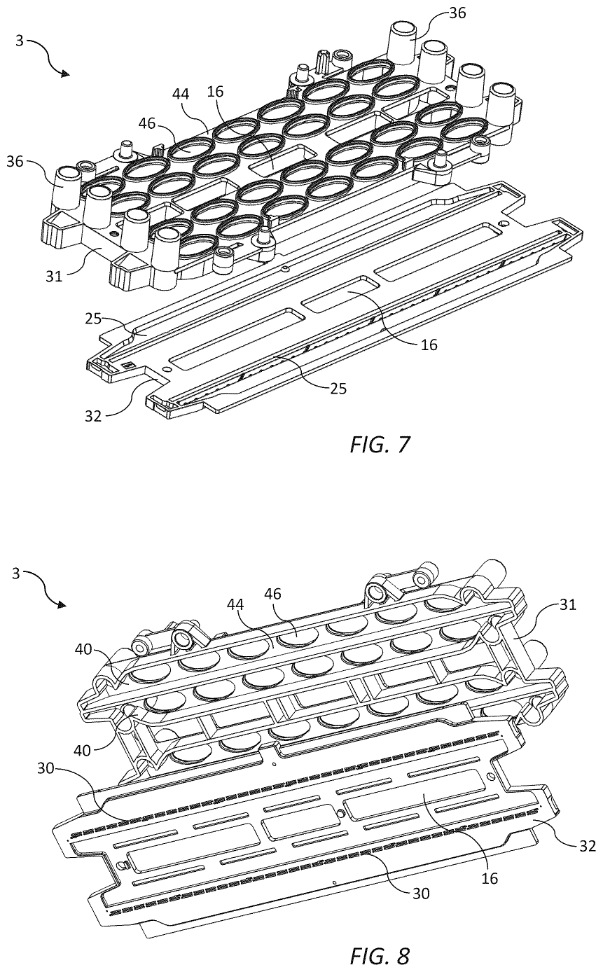

The manifold 3 typically takes the form of an LCP molding, which may be manufactured in high volumes and at relatively low cost. For ease of manufacturing, and as best shown in the exploded views of FIGS. 7 and 8, the manifold 3 exemplified herein is a two-part LCP molding having an upper molding 31 and a lower molding 32 bonded together with a suitable adhesive. While a two-part LCP molding is exemplified herein, it will of course be appreciated that the manifold 3 may be a one-part molding or a multi-part molding having three or more bonded parts.

The lower molding 32 defines four ink supply channels 25 extending along its length and suitable for supplying four colors of ink (e.g., CMYK) to the first and second rows of print chips 5A and 5B (two colors per row of print chips). The ink supply channels 25 are tapered towards rows of ink outlets 30 defined in the base of the lower molding 32, each respective pair of ink supply channels supplying ink to a paired row of ink outlets 30 defined in the base of the lower molding 32, which in turn feed ink into the backsides of print chips 5 contained in either the first row 5A or the second row 5B.

The upper molding 31 defines four ink ducts 40 extending along a length thereof, each ink duct being configured to supply ink to a respective one of the ink supply channels 25 of the lower molding 32. Ink connectors 36 of the upper molding 31 supply and receive ink from opposite ends of each ink duct 40 so that ink can flow along the length of the manifold 3 between respective inlet and outlet connectors.

Referring now to FIG. 5, the ink ducts 40 each have a larger volume than their corresponding ink channels 25 to provide a local reservoir of ink for the print chips 5. Each ink duct 40 has first and second opposite duct sidewalls 42A and 42B, and a roof 44 defining a plurality of elliptical openings 46 (see FIG. 4) spaced apart in a row along a length thereof. Each opening 46 is sealed with a compliance unit 48 comprised of a gasket 50 and a rigid member in form of a plug 52. For ease of manufacturing and assembly of the printhead 1, the gaskets 50 for each paired row of ink ducts 40 are interconnected to form a single molded piece; likewise, the corresponding plugs 52 are interconnected to form a single molded piece (see FIG. 6).

Each gasket 50 comprises an upper gasket rim 60 seated on a perimeter lip 54 of the elliptical opening 46 and a perimeter seal 58 extending downwardly from the rim. Each plug 52 has rigid plug sidewalls 56 received within the perimeter lip 54, such that the perimeter seal 58 is radially sealingly engaged between the plug sidewalls and the perimeter lip. A radial (or ‘gland’) seal between the gasket 50 and the perimeter lip 54 provides an effective seal without requiring a high axial compression force. Nevertheless, at least some axial compression force is still required to secure the gasket rim 60 against the perimeter lip 54 and this axial compression force is provided by a rigid cover plate in the form of the upper PCB 12, which is fastened to the manifold 3 via screw fasteners 13. The upper PCB 12 squeezes the gasket rim 60 against the perimeter lip 54 via a perimeter flange 63 of the plug 52 to secure the gasket 50 and plug 52 in place.

The gasket 50 further provides a pressure-dampening function via a compliance portion 62 extending between opposite perimeter seals 58. The compliance portion 62 is spaced apart from the plug 52 and has a generally wavelike profile, which communicates with ink held in the ink duct. Accordingly, the compliance portion 62 can flex towards and away from the plug 52 in response to ink pressure changes and thereby dampen hydrostatic pressure fluctuations. Each plug 52 defines a vent 64 to enable flexing of the compliance portion 62 in this manner.

As well as enabling sufficient flexing of the gasket 50 to dampen pressure fluctuations during printing, the plug 52 is also configured to limit flexing of the gasket during, for example, priming of the printhead 1. Priming of printheads using positive ink pressure is not possible with overly damped ink ducts and, therefore, configuring the plugs 52 to limit excessive flexing of the gasket 50 provides a versatile printhead 1 suitable for priming via positive ink pressure.

In order to limit flexing of the gasket 50, the plug 52 comprises a tongue 66 extending towards a floor of the ink duct 40, while the gasket has a hanging portion 68 (generally U-shaped in cross-section), which extends around the tongue so as to be spaced apart therefrom. The hanging portion 68 is positioned proximal the first duct sidewall 42A relative to the second duct sidewall 42B, and the wavelike compliance portion 62 of the gasket 50 extends generally diagonally upwards towards the second duct sidewall 42B from the hanging portion. Accordingly, the compliance portion 62 of each ink duct 40 faces its respective ink supply channel 25 for optimizing pressure-dampening of ink supplied to the print chips 5. During normal printing, the compliance portion 62 flexes sufficiently to dampen pressure fluctuations along the ink duct 40; whereas during priming of the printhead using positive ink pressure, flexing of the compliance portion 62 is limited by the rigid tongue 66.

It will be appreciated that the gasket 50 is typically formed from compliant polymer to allow flexing thereof, while the plug 52 is typically formed from a relatively rigid polymer to secure the gasket in place as well as limit flexing of the gasket.

It will, of course, be appreciated that the present disclosure has been described by way of example only and modifications of detail may be made within the scope of the disclosure, which is defined in the accompanying claims.

1. A compliance assembly for dampening ink pressure fluctuations in an inkjet printing system, said compliance assembly comprising:
an ink duct having duct sidewalls and an opening defined in a roof of the ink duct;
a gasket covering the opening, the gasket comprising a compliance portion communicating with ink in the ink duct; and
a rigid member urged against the gasket for sealing the opening, wherein:
the compliance portion is spaced apart from the rigid member; and
the rigid member comprises a tongue extending towards a floor of the ink duct, such that flexing of the compliance portion is limited by the tongue.

2. The compliance assembly of claim 1, wherein the rigid member has at least one vent enabling flexing of the compliance portion in response to ink pressure fluctuations in the ink duct.

3. The compliance assembly of claim 1, wherein the gasket hangs between first and second opposite duct sidewalls.

4. The compliance assembly of claim 1, wherein the compliance portion has a wavelike profile.

5. The compliance assembly of claim 1, wherein the gasket is axially urged against upper edges of the duct sidewalls by the rigid member, the gasket being sandwiched between the rigid member and the upper edges.

6. An inkjet printhead comprising one or more compliance assemblies according to claim 1.
